(19) United States
(12) Patent Application Publication
(10) Pub. No.: US 2020/0157369 A1
(43) Pub. Date: May 21, 2020

(54) CONDUCTIVE INK COMPOSITIONS COMPRISING GOLD AND METHODS FOR MAKING THE SAME

(71) Applicant: ELECTRONINKS INCORPORATED, Austin, TX (US)

(72) Inventor: Steven Brett WALKER, Austin, TX (US)

(21) Appl. No.: 16/636,150

(22) PCT Filed: Aug. 3, 2018
(86) PCT No.: PCT/US18/45277

§ 371 Date: Feb. 3, 2020

Related U.S. Application Data
(60) Provisional application No. 62/540,903, filed on Aug. 3, 2017.

(51) Int. Cl. C09D 11/52; C09D 11/037; C09D 11/033; C09D 11/102; C09D 11/104; C09D 11/322; C09D 11/36

(52) U.S. Cl. CPC C09D 11/52; C09D 11/037; C09D 11/033; C09D 11/36; C09D 11/104; C09D 11/322; C09D 11/102

(57) ABSTRACT

A particle-free gold-complex based ink is described wherein a gold carboxylate is complexed with an amine. Upon heating the solution, the gold cation catalyzes the oxidative amidation of the amine with the carboxylate to form a short chain or polymeric amide while simultaneously reducing the gold cation to metallic gold. This method is extremely versatile and allows for both the preparation of pure metallic gold films as well as polymer gold composites with unique properties.

### CROSS-REFERENCE TO RELATED APPLICATION

This application claims the benefit of U.S. Provisional Application No. 62/540,903, filed on Aug. 3, 2017, the disclosure of which is incorporated herein by reference in its entirety.

### FIELD OF THE INVENTION

The present disclosure is related generally to compositions of conductive gold ink and methods for making the same.

### BACKGROUND OF THE INVENTION

The vast majority of commercially produced conductive inks are specifically designed for inkjet, screen-printing, or roll-to-roll processing methods in order to process large areas with fine-scale features in short time periods. These inks have disparate viscosities and synthesis parameters. Particle-based inks are based on conductive metal particles, which are typically synthesized separately and then incorporated into an ink formulation. The resulting ink is then tuned for the specific particle process. Precursor-based inks are based on thermally unstable precursor complexes that reduce to a conductive metal upon heating. Prior particle- and precursor-based methods generally rely on high temperatures to form conductive coatings and thus may not be compatible with substrates that require low processing temperatures to maintain integrity.

What is needed in the art are better compositions and methods for creating high quality conductive metal ink at a conversion temperature that is lower than that of existing conductive ink compositions such as a silver-based ink. What is also needed are ink compositions that are stable and can be stored at room temperature.

### SUMMARY OF THE INVENTION

Improved ink compositions for forming conductive structures comprising gold and methods of making the conductive structures are described herein.

In one aspect, disclosed herein are ink compositions for making a conductive gold structure. The ink compositions comprise: a gold salt; and a complexing agent, optionally further comprising a short chain carboxylic acid or salt thereof, wherein the gold salt is a carboxylate, or the gold salt is capable of forming a carboxylate with the short chain carboxylic acid or with a salt thereof.

In some embodiments, the gold salt is a gold (I) salt, a gold (II) salt, or a gold (III) salt. In some embodiments, the gold salt is or comprises gold(III) formate, gold(III) acetate, gold(III) propionate, gold(III) lactate, gold(III) oxalate, gold(III) carbonate, gold(III) nitrate, gold(III) nitrite, gold(III) phosphate, gold(III) oxide, gold(III) fluoride, gold(III) bromide, gold(I) chloride, gold(III) chloride, gold(III) chloride trihydrate, gold(III) hydroxide, gold(I) iodide, hydrogen tetrabromoaurate(III) hydrate, potassium gold(III) chloride, or gold(III) terephthalate.

In some embodiments, the gold salt is a gold carboxylate.

In some embodiments, the molar ratio of complexing agent to the gold salt is around 6:1.

In some embodiments, the complexing agent is or comprises an alkyl amine or ammonia. In some embodiments, the alkyl amine is or comprises a primary amine, a secondary amine, or a polyamine.

In some embodiments, the alkyl amine is selected from the group consisting of methylamine, dimethylamine, ethylamine, diethylamine, propylamine, dipropylamine, butylamine, dibutylamine, amylamine, isoamylamine, dipentylamine, and combinations thereof.

In some embodiments, the alkyl amine is selected from the group consisting of methylamine, dimethylamine, ethylamine, diethylamine, propylamine, dipropylamine, butylamine, dibutylamine, amylamine, dipentylamine, and combinations thereof.

In some embodiments, the short chain carboxylic acid is selected from the group consisting of formic acid, acetic acid, propionic acid, lactic acid, oxalic acid, citric acid, and citraconic acid.

In some embodiments, the citraconic acid is generated from citraconic anhydride.

In some embodiments, the short chain carboxylic acid is selected from the group consisting of formic acid, acetic acid, propionic acid, lactic acid, oxalic acid, and citric acid.

In some embodiments, the composition further comprises methylene diamine or ethylene diamine.

In some embodiments, the composition further comprises a solvent selected from the group consisting of ethanol, butanol, propylene glycol, water, and combinations thereof.

In some embodiments, the gold salt is gold(III) formate, and the complexing agent is selected from the group consisting of methylamine, dimethylamine, ethylamine, diethylamine, propylamine, dipropylamine, butylamine, dibutylamine, amylamine, dipentylamine, ammonia, and combinations thereof.

In some embodiments, the complexing agent is selected from the group consisting of methylamine, dimethylamine, ethylamine, diethylamine, propylamine, dipropylamine, butylamine, dibutylamine, amylamine, dipentylamine, ammonia, and combinations thereof, and the short chain carboxylic acid is acetic acid.

In some embodiments, the composition further comprises ethylene diamine.

In some embodiments, the composition further comprises a solvent selected from the group consisting of ethanol, butanol, propylene glycol, water, and combinations thereof.

In another aspect, disclosed herein are alternative ink compositions for making a conductive structure comprising gold. The ink compositions comprise: a gold salt of an organic acid; a monomeric building block; and a solvent having a boiling point of about 160° C. or less; where the conjugate base of the organic acid reacts with the monomeric building block to form a polymer while ionic gold is reduced to elemental gold.

In some embodiments, the polymer is a polyamide, a polyimide, a polyamideimide, or a polyester.

In some embodiments, the organic acid comprises a dicarboxylic acid selected from the group consisting of oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), sebacic acid (decanedioic acid), undecanedioic acid, dodecanedioic acid, tridecanedioic acid, hexadecanedioic acid, and terephthalic acid.

In some embodiments, the monomeric building block comprises a diamine, an N-silylated diamine, or a diisocyanate.

In some embodiments, the diamine comprises a linear aliphatic diamine, a branched aliphatic diamine, a cyclic aliphatic diamine, or an aromatic diamine.

In some embodiments, the monomeric building block is selected from the group consisting of ethylenediamine (1,2-diaminoethane), an N-alkylated diamine, 1,1-dimethylethylenediamine, 1,1-dimethylethylenediamine, tetramethylethylenediamine (TMEDA), ethambutol, TMEDA, 1,3-diaminopropane (propane-1,3-diamine), putrescine (butane-1,4-diamine), cadaverine (pentane-1,5-diamine), or hexamethylenediamine (hexane-1,6-diamine), ethylenediamine, 1,2-diaminopropane, diphenylethylenediamine, trans-1,2-diaminocyclohexane, 1,4-Diazacycloheptane, o-xylylenediamine (OXD), m-xylylenediamine (MXD), p-xylylenediamine (PXD), o-phenylenediamine (OPD), m-phenylenediamine (MPD), p-phenylenediamine (PPD), 2,5-diaminotoluene, an N-methylated derivative of a phenylenediamine, imethyl-4-phenylenediamine, N,N′-di-2-butyl-1,4-phenylenediamine, a diamine with two aromatic rings, 4,4′-diaminobiphenyl or 1,8-diaminonaphthalene, toluene diisocyanate (TDI), methylene diphenyl diisocyanate (MDI), hexamethylene diisocyanate (HDI), methyl isocyanate (MIC), and isophorone diisocyanate (IPDI).

In some embodiments, the polymer is a polyimide formed from a poly(amic acid) precursor, a polyisoimide precursor, a mixture of a diester-acid and a diamine, a mixture of a tetracarboxylic acid and a diamine, a mixture of a dianhydride and a diisocyanate, a polyetherimide via a nucleophilic aromatic substitution reaction, or a mixture of 4,4′-methylenediphenyldiisocyanate (MDI) and trimellitic anhydride (TMA).

In some embodiments, the polyester is selected from the group consisting of polyethylene adipate (PEA), polybutylene succinate (PBS), poly(3-hydroxybutyrate-co-3-hydroxyvalerate) (PHBV), polyethylene terephthalate (PET), polybutylene terephthalate (PBT), polytrimethylene terephthalate (PTT), polyethylene naphthalate (PEN), and Vectran.

In yet another aspect, disclosed herein are methods of making conductive structures comprising gold. The methods comprise: providing a metal salt composition comprising a gold salt and a complexing agent; adding a short chain carboxylic acid or a salt of the short chain carboxylic acid to the combined metal salt composition and complexing agent to form an ink composition; optionally partially evaporating the complexing agent from the ink composition to form a concentrated formulation; and reducing the metal salt composition to form a conductive structure comprising gold, wherein the concentrated formulation and the conductive structure comprising gold are formed at a temperature of about 160° C. or less.

In some embodiments, the temperature is about 140° C. or less.

In some embodiments, the short chain carboxylic acid or the salt of the short chain carboxylic acid is not added until after the gold salt is dissolved in the complexing agent.

In some embodiments, the method further comprises depositing the ink composition onto a substrate.

In some embodiments, the ink composition is deposited onto the substrate by a method selected from the group consisting of spray processing, dip coating, spin coating, inkjet printing, and e-jet printing.

In some embodiments, the method further comprises depositing the concentrated formulation onto a substrate.

In some embodiments, the concentrated formulation is deposited onto the substrate by a method selected from the group consisting of screen printing, roll-to-roll processing, and direct ink writing.

In still yet another aspect, disclosed herein are alternative methods of making conductive structures comprising gold. The methods comprise: providing a gold salt of an organic acid and a monomeric building block; and causing polymer formation between the conjugate base of the organic acid and the monomeric building block.

One of skill in the art would understand that, when applicable, any embodiments disclosed herein can be applied in any aspect.

### DETAILED DESCRIPTION OF THE INVENTION

Disclosed herein are precursor-based gold conductive ink compositions, preferably having one or more of the following characteristics. First, the formation of a gold conductive structure from the ink composition can be catalyzed by gold ion within the ink itself, in the absence of a catalyst. This characteristic is fundamentally different from previously known precursor-based conductive inks such as the silver conductive ink compositions disclosed in U.S. Pat. No. 9,469,773. Second, the elemental gold generated from the ink composition is pure and not contaminated with by-products. Third, the ink composition may possess low viscosity, so that it is compatible with a broad range of patterning techniques, including direct ink writing, inkjet printing, and airbrush spraying. Fourth, the patterned features prepared using the ink composition may be highly conductive at room temperature and achieve bulk conductivity upon annealing at mild temperatures (e.g., <140° C.).

As used herein, the terms “conductive ink composition”, “conductive ink”, “ink composition”, “ink”, or variations thereof, can be used interchangeably.

As disclosed herein, a conductive “gold ink composition” refers to ink compositions including, but not limited to, a gold salt. For example, while disclosure is provided herein of solvents and complexing agents comprising a gold salt, this disclosure should in no way limit the ink compositions to only those compositions containing a gold salt as the sole metal source. In some embodiments, a conductive gold ink composition may comprise another metal salt; for example, a palladium salt can be added to promote stability of the conductive ink.

In one aspect of the disclosure, a gold conductive structure is obtained through a gold-catalyzed amidation reaction. For example, a gold salt (e.g., a gold carboxylate salt) can be dissolved in an amine solution, where the amine reacts with the carboxyl group in the gold carboxylate to form an amide, and ionic gold is reduced to the elemental form. In such reactions, the amine functions as both a complexing agent and as a reducing agent.

The above-described gold-catalyzed amidation reaction can take place at a temperature around 120° C. At such a temperature, all the liquid products are evaporated, leaving only conductive elemental gold. In some cases, however, it may be advantageous for the reaction to be run at lower temperatures, for example around 100° C., around 80° C., around 60° C., or at even lower temperatures. The instant inventor has discovered that the temperature of the reaction can be modulated by the choice of carboxylic acid used to form the gold carboxylate. For example, the reaction temperature can be as low as 60° C., or even lower, by selection of an appropriate carboxylic acid for use in the ink composition. In some cases, liquid products may remain after formation of the elemental gold. The remaining liquid products may be removed by evaporation in a subsequent step or may be removed by other means, as appropriate for the situation and conditions.

Accordingly, in some embodiments are provided ink compositions for making a conductive gold structure, the ink compositions comprising: a gold salt, and a complexing agent, optionally further comprising a short chain carboxylic acid or salt thereof, wherein the gold salt is a carboxylate, or the gold salt is capable of forming a carboxylate with the short chain carboxylic acid or with the salt thereof. Said another way, the disclosure provides ink compositions for making a conductive gold structure, the ink compositions comprising: a gold salt; and one of (a) a complexing agent; (b) a complexing agent and a short chain carboxylic acid, or (c) a complexing agent and a salt of a short chain carboxylic acid, wherein the gold salt is a carboxylate, or the gold salt is capable of forming a carboxylate with the short chain carboxylic acid or with a salt thereof.

Gold salts finding use in the instant compositions include without limitation gold(III) formate, gold(III) acetate, gold(III) propionate, gold(III) lactate, gold(III) oxalate, or a mixture of these. In some embodiments, gold(III) butyrate and gold(III) pentanoate can also be used if the reaction temperature is higher.

Additional gold salts, including gold(I) salts and gold(II) salts can also be used.

In some embodiments, the reaction temperature is 180° C. or lower, 170° C. or lower, 160° C. or lower, 150° C. or lower, 140° C. or lower, 130° C. or lower, 120° C. or lower, 110° C. or lower, 100° C. or lower, 90° C. or lower, or 80° C. or lower. In some embodiments, the reaction temperature may be higher than 180° C.

In some embodiments, the only conductive material in the gold ink composition is gold. In some embodiments, multiple conductive materials are included in a gold ink; for example, palladium can be used as a stabilizing agent. Additional information on the stabilizing property of palladium can be found in U.S. Provisional Patent Application No. 62/540,829, filed Aug. 3, 2017 and entitled “Conductive Ink Compositions Comprising Palladium and Methods for Making the Same”, which is hereby incorporated by reference in its entirety.

In one embodiment, the complexing agent is an alkyl amine. To form the conductive ink, the gold salt is dissolved in the alkyl amine. An alkyl amine is an amino group substituted by at least one C₁₋₈ alkyl group, where an alkyl group refers to a hydrocarbon group which may be linear, cyclic, or branched or a combination thereof having the number of carbon atoms designated (i.e., C₁₋₈ means one to eight carbon atoms). Examples of alkyl groups include methyl, ethyl, n-propyl, isopropyl, n-butyl, t-butyl, isobutyl, sec-butyl, pentyl, isopentyl, cyclohexyl, cyclopentyl, and the like. An alkyl amine may be a primary, secondary or tertiary amine, preferably a primary amine. In some cases, one or more of the carbon atoms in the alkyl group can be substituted with a heteroatom, such as an oxygen, a sulfur, or a nitrogen.

The alkyl amine, which is a weak base, acts as a reducing agent for the gold salt through an amidation reaction. Additionally, it also functions as a stabilizer and solvent for the gold salt. Any suitable alkyl amine that reduces or stabilizes the gold salt or additional metal salt may be employed. In some embodiments, the alkyl amine has a boiling point of about 140° C. or less. In some embodiments, the alkyl amine has a boiling point of about 120° C. or less. In some embodiments, the alkyl amine has a boiling point of about 100° C. or less. Examples of alkyl amines having a boiling point of about 120° C. or less include but are not limited to isomers of C₆H₁₅N, isomers of C₅H₁₃N, isomers of C₄H₁₁N, isomers of C₃H₉N, isomers of C₂H₇N, and isomers of CH₅N. For convenience in handling, it may be desirable for the alkyl amine to have a boiling point of about 40° C. or greater. Examples of alkyl amines having boiling points between about 40° C. and 180° C. include, but are not limited to methylamine, ethylamine, aniline, propylamine, n-butyl amine, amylamine, isoamylamine, s-butylamine, iso-butylamine, isopentylamine, 1-methylbutylamine, 1-amino-2-methylbutane, N-methyldiethylamine, diethylamine, di propylamine, dibutylamine, and dipentylamine. Alkyl amines comprising ether linkages, for example methoxyethylamine and the like, are also considered suitable for use in the instant compositions. Preferably the amine is propylamine, n-butyl amine, or amylamine; more preferably propylamine or n-butylamine.

In some embodiments, the alkyl amine is selected from the group consisting of methylamine, ethylamine, propylamine, butylamine, amylamine, isoamylamine, and methoxyethylamine. In some embodiments, the alkyl amine is selected from the group consisting of methylamine, ethylamine, propylamine, butylamine, and amylamine.

The alkyl amine may be selected based on its boiling point for a specific application. For deposition methods such as inkjet printing or e-jet, greater stability is generally preferred, and thus it may be preferable to use an alkyl amine with a higher boiling point such as amyl amine which has a boiling point of about 104° C. In some aspects it may be desirable to add a short chain diamine (e.g., methylenediamine or ethylenediamine) in addition to the alkyl amine to provide even more stability. However, when ethylenediamine is used alone, the electrical conductivity of the resulting gold-containing product may not be as high as desired. Therefore, it may be advantageous to employ a combination of an alkyl amine and ethylenediamine, such as amyl amine with ethylenediamine in a given ratio to prepare the gold-based ink. The ratio of alkyl amine to ethylenediamine may fall in the range from about 4:1 to about 1:4 on a volume:volume basis, and is preferably about 1:1. Another short chain diamine such as, for example, methylenediamine may be used instead of, or in addition to, ethylenediamine.

In some embodiments, to form the conductive ink, enough alkyl amine can be added to promote the amidation reaction between the short chain gold carboxylate and the alkyl amine. Preferably an excess of alkyl amine is used relative to the short chain carboxylic acid to ensure that the short chain carboxylic acid is complexed and thereby unavailable to act as a reducing agent. The molar ratio of the alkyl amine to the short chain carboxylate is at least about 1:1, preferably at least about 3:1, more preferably at least about 6:1. In some embodiments, the molar ratio of the alkyl amine to the short chain carboxylate is greater than 6:1. For ease of operability, it may be desirable to add enough amine to dissolve the gold salt or any additional metal salt. The amount of alkyl amine required may be determined by slowly adding the alkyl amine to the gold salt and any additional metal salt and monitoring the dissolution of the gold salt and any additional metal salt. In some aspects, about 2 mL of alkyl amine may be used to dissolve about 1 g of gold salt or any additional metal salt. Other methods known to one skilled in the art to assist in dissolution of the gold salt and any additional metal salt including addition of a solvent or other component such as a higher molecular weight alkyl amine or a diamine to assist in dissolution are also contemplated.

In some aspects, it may be desirable to add a solvent to the mixture of the alkyl amine and gold salt (and any additional metal salt). The solvent preferably has a boiling point of at most 180° C. Examples of suitable solvents include water, alcohols (including for example, methanol, ethanol, 1-propanol, and 2-propanol), esters, ketones, and ethers. Preferably the solvent is water, ethanol, butanol, or propylene glycol. In some aspects, the solvent may include two or more co-solvents. For example, the solvent may include water and another co-solvent such as butanol or propylene glycol.

In another embodiment, the complexing agent is ammonium hydroxide (e.g., ammonia or aqueous ammonia). To form the conductive ink, the gold salt (and any additional metal salt, if applicable) is dissolved in the ammonium hydroxide. The ammonium hydroxide, which is a weak base, acts as a stabilizer and solvent for the gold salt (and any additional metal salt, if applicable). The ammonium hydroxide is not intended to act as a reducing agent for the gold ink composition (i.e., it does not appreciably reduce the gold salt or any additional metal salt, if applicable).

In another aspect of the disclosure, to form the conductive ink composition, a short chain carboxylic acid can be added to the composition (e.g., in addition to gold carboxylate salt and alkyl amine). In any of the embodiments described herein, preferably, after dissolving the gold salt (and any additional metal salt, if applicable) in the complexing agent, the short chain carboxylic acid is added to form an ink formulation. The short chain carboxylic acid can function as the reducing agent for the gold salt (and any additional metal salt, if applicable). Alternatively, or additionally, a salt (e.g., an ammonium salt) of the short chain carboxylic acid may be added to form the ink formulation. The salt of the short chain carboxylic acid may function as the reducing agent for the gold salt (and any additional metal salt, if applicable), generally as described herein with reference to the short chain carboxylic acid. Without wishing to be bound by theory, it is believed that by adding the short chain carboxylic acid in the presence of the complexing agent, an acid-base complex is formed between the short chain carboxylic acid and the complexing agent, thereby preventing the short chain carboxylic acid from reducing the gold salt (and any additional salt, if applicable) immediately. As the ink formulation is concentrated and the complexing agent is removed by suitable conditions including evaporation, the short chain carboxylic acid becomes liberated and reduction of the gold salt to elemental gold (gold in the zero oxidation state) by the short chain carboxylic acid may occur. When one or more additional metal salts are present (e.g., a silver salt or a palladium salt), the additional metal salt(s) will be reduced to their corresponding elemental metal forms too.

In some embodiments, the short chain carboxylic acid can have a chain length of seven carbons or less and typically has a chain length of five carbons or less. Examples of short chain carboxylic acids include, but are not limited to, formic acid, acetic acid, propionic acid, butyric acid, and pentanoic acid. Preferably, the short chain carboxylic acid has a chain length of two carbons or less. More preferably the short chain carboxylic acid is formic acid. Formic acid has been found to be particularly advantageous due to its low boiling point and volatile byproducts. Formic acid comprises an aldehyde functionality, which enhances its reducing ability. As the gold salt is reduced to elemental gold, formic acid in turn is oxidized to carbonic acid, which in turn forms carbon dioxide and water, both of which are volatile byproducts. As such, short chain carboxylic acids comprising an aldehyde functionality are preferred short chain carboxylic acids. Additionally, the use of formic acid may result in the formation of carbon dioxide and water, leaving no residual reducing agent.

In the alternative aspects of the disclosure, the short chain carboxylic acid is a reducing agent for the gold salt (or any additional metal salt, when applicable), but due to the complexation with the complexing agent that occurs upon adding the short chain carboxylic acid to the mixture, the acid is substantially prevented from reducing the gold salt. Generally, reduction of the gold salt does not occur until the complexing agent is partially or completely evaporated from the ink formulation. The complexing agent may be evaporated after deposition of the ink formulation onto a desired substrate, at which time the acid reduces the gold salt to form a conductive gold coating or other gold structure on the substrate. Alternatively, the complexing agent may be partially evaporated from the ink during a further processing step in order to increase the viscosity of the ink and form a concentrated formulation for use in a printing technique such as direct ink writing. In this case, partial reduction of the gold salt may occur prior to deposition, such that the ink may have a composite structure including a mixture of unreacted gold salt along with conductive gold particles (e.g., nanocrystals) formed during the partial reduction. The viscosity of such a composite ink may be tailored for printing techniques such as direct ink writing, where the ink must span gaps during fabrication of three-dimensional structures. Evaporation of the complexing agent typically occurs at an elevated temperature below about 120° C., or between about 50° C. and 100° C., or between about 60° C. and 90° C. The evaporation may occur over a period of minutes or hours, depending on the volatility of the complexing agent and the temperature at which the evaporation is carried out. The complexing agent may also be evaporated at room temperature over a longer time period. In some cases, the evaporation may be performed under reduced pressure. In embodiments where a silver salt is present as an additional metal salt, UV light may also be used to accelerate the reaction instead of heat, since UV light will reduce silver salts.

In some embodiments, it may be desirable to add a solvent to the mixture of the ammonium hydroxide and gold salt (and any additional metal salt, if applicable). The solvent preferably has a boiling point of at most 160° C. Examples of suitable solvents include water, alcohols (including for example, methanol, ethanol, 1-propanol, and 2-propanol), esters, ketones, and ethers. Preferably the solvent is water or ethanol.

Preferably, particle formation may only occur after patterning, as evaporation ensues. A highly conductive gold structure remains after the reduction, even at low processing temperatures, because the low boiling points of non-gold constituents allow for a controlled and complete, or nearly complete, removal of the non-gold constituents.

In another aspect, the gold conductive structure is obtained through gold catalyzed polymerization. For example, elemental gold can be formed by combining the gold salt of an organic acid with a monomeric building block, where the conjugate base of the organic acid reacts with the monomeric building block to form a polymer material, while yielding elemental gold. In some embodiments, the resulting polymer is a polyamide. In some embodiments, the resulting polymer is a polyimide. In some embodiments, the resulting polymer is a polyamideimide. In some embodiments, the resulting polymer is a polyester.

Typically, formation of polyamides requires activating groups such as carbonyl chloride in addition to carboxylates and diamines building blocks for polymerization to occur at low temperatures (<140° C.). Hazardous byproducts such as hydrochloric acid are often formed. As disclosed herein, elemental gold can function as a catalyst to avoid the formation of hazardous byproducts.

In some embodiments, the polyamide is formed between a gold salt of an organic acid and a diamine. In some embodiments, the polyamide is formed by a diisocyanate and a gold salt of an organic acid.

In some embodiments, the organic acid is a dicarboxylic acid. Exemplary dicarboxylic acids include but are not limited to oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), Suberic acid (octanedioic acid), azelaic acid (nonanedioic acid), sebacic acid (decanedioic acid), undecanedioic acid, dodecanedioic acid, tridecanedioic acid, hexadecanedioic acid, and terephthalic acid. In some embodiments, the organic acid is terephthalic acid.

In some embodiments, the monomeric building block is a diamine. In some embodiments, the monomeric building block is an N-silylated diamine. In some embodiments, the monomeric building block is a diisocyanate.

In some embodiments, the diamine is a linear aliphatic diamine, including, but not limited to, ethylenediamine (1,2-diaminoethane), an N-alkylated diamine, 1,1-dimethylethylenediamine, 1,1-dimethylethylenediamine, tetramethylethylenediamine (TMEDA), ethambutol, TMEDA, 1,3-diaminopropane (propane-1,3-diamine), putrescine (butane-1,4-diamine), cadaverine (pentane-1,5-diamine), or hexamethylenediamine (hexane-1,6-diamine).

In some embodiments, the diamine is a branched aliphatic diamine, including, but not limited to, ethylenediamine or derivatives thereof such as 1,2-diaminopropane, diphenylethylenediamine, or trans-1,2-diaminocyclohexane.

In some embodiments, the diamine is a cyclic aliphatic diamine such as 1,4-Diazacycloheptane. In some embodiments, the diamine is a xylylenediamine including, but not limited to, o-xylylenediamine (OXD), m-xylylenediamine (MXD), or p-xylylenediamine (PXD).

In some embodiments, the diamine is an aromatic diamine, including, but not limited to, o-phenylenediamine (OPD), m-phenylenediamine (MPD), p-phenylenediamine (PPD), or 2,5-diaminotoluene (which is related to PPD but contains a methyl group on the ring).

In some embodiments, the diamine includes various N-methylated derivatives of the phenylenediamines such as imethyl-4-phenylenediamine or N,N′-di-2-butyl-1,4-phenylenediamine.

In some embodiments, the diamine includes a diamine with two aromatic rings and derivatives thereof such as 4,4′-diaminobiphenyl or 1,8-diaminonaphthalene.

In some embodiments, the diisocyanate includes, but is not limited to, toluene diisocyanate (TDI), methylene diphenyl diisocyanate (MDI), hexamethylene diisocyanate (HDI), methyl isocyanate (MIC), or isophorone diisocyanate (IPDI).

In some embodiments, the polymer is a polyimide derivatized from poly(amic acid) precursors. In some embodiments, the polyimide is formed from polyisoimide precursors. In some embodiments, the polyimide is formed from a diester-acid and a diamine. In some embodiments, the polyimide is formed from a tetracarboxylic acid and a diamine. In some embodiments, the polyimide is formed from a dianhydride and a diisocyanate. In some embodiments, the polyimide is formed from a polyetherimide via a nucleophilic aromatic substitution reaction.

In some embodiments, the polymer is a polyamideimide formed between, for example, 4,4′-methylenediphenyldiisocyanate (MDI) and trimellitic anhydride (TMA).

In some embodiments, the polymer is a polyester formed between a gold salt of a dicarboxylic acid and a diol. Exemplary polyester includes polyethylene adipate (PEA), polybutylene succinate (PBS), poly(3-hydroxybutyrate-co-3-hydroxyvalerate) (PHBV), polyethylene terephthalate (PET), polybutylene terephthalate (PBT), polytrimethylene terephthalate (PTT), polyethylene naphthalate (PEN) or Vectran.

| Exemplary Polyester | Exemplary Ink Composition |
|---|---|
| Polyethylene adipate (PEA) | Gold salt of adipic acid with |
| | polyethylene glycol |
| Polybutylene succinate (PBS) | Gold succinate with 1,4-butanediol |
| Poly(3-hydroxybutyrate-co-3- | Gold salt of 3-hydroxybutanoic acid and |
| hydroxyvalerate) (PHBV) | 3-hydroxypentanoic acid, butyrolactone, |
| | and valerolactone (oligomeric |
| | aluminoxane as a catalyst) |
| Polyethylene terephthalate | Gold terephthalate with ethylene glycol |
| (PET) | |
| Polybutylene terephthalate | Gold terephthalate with 1,4-butanediol |
| (PBT) | |
| Polytrimethylene terephthalate | Gold terephthalate with 1,3-propanediol |
| (PTT) | |
| Polyethylene naphthalate | Gold naphthalene dicarboxylate with |
| (PEN) | ethylene glycol |
| Vectran | Gold salt of 4-hydroxybenzoic acid with |
| | 6-hydroxynaphthalene-2-carboxylic acid |

In some embodiments, it may be desirable to add a solvent to the polymerization mixture of gold salt and monomeric building blocks. The solvent preferably has a boiling point of at most 160° C. Examples of suitable solvents include water, alcohols (including for example, methanol, ethanol, 1-propanol, and 2-propanol), esters, ketones, and ethers. Preferably the solvent is water or ethanol.

It will be readily apparent to one of ordinary skill in the relevant arts that other suitable modifications and adaptations to the methods and applications described herein can be made without departing from the scope of the invention or any embodiment thereof. Having now described the present invention in detail, the same will be more clearly understood by reference to the following Examples, which are included herewith for purposes of illustration only and are not intended to be limiting of the invention.

### EXAMPLES

The following non-limiting examples are provided to further illustrate embodiments of the invention disclosed herein. It should be appreciated by those of skill in the art that the techniques disclosed in the examples that follow represent approaches that have been found to function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

### Example 1. Gold Catalyzed Amidation

Gold ionic inks can be made by complexation with 6 nitrogens from groups consisting of ammonia, primary amines, secondary amines, or polyamines and a stoichiometric amount of a carboxylate counter-ion to the ionic valence of the gold species. For example, typically Gold (III) acetate could be dissolved in ammonia or amines to create the corresponding amide at moderate temperatures (80-140° C.). Other carboxylate counter-ions could be used such as polycarboxylates or other single carboxylates from a gold salt.

Additionally, gold oxide or other gold salts could be dissolved in solution with the corresponding carboxylic acid and nitrogen containing groups to create the corresponding amide or polyamide.

For example, 1 mMol of Au(III) acetate was dissolved with 6 mMol of dibutylamine to create a translucent yellow solution that is predominantly free of particles. Upon deposition on a substrate and heating to 120° C., a gold film was formed during the formation of dibutylacetamide.

Similarly, when 6 mMol of methylamine is used, at 120° C., a gold film was formed while methylacetamide was produced.

When an electron withdrawing group such as a halide (preferentially a fluoride) was added to the amine such as perfluorinated dibutylamine, the reaction occurred at a much lower temperature, in some cases as low as 80° C.

### Example 2. Gold Catalyzed Polymerization

Here, Au(III) terephthalate was mixed with 1,4-phenylene diamine in alcohol. At 120° C., the solution was polymerized in less than 5 minutes. At 100° C., the solution was polymerized in under 10 minutes. Notably, the polymer film is immediately metallized with a gold film on the surface with no byproducts.

### Example 3. Alternative Gold Ink Composition

An alternative gold ink composition is provided, as follows: a gold (III) citraconate salt is synthesized by mixing gold (III) hydroxide with citraconic anhydride (1:1.5 to 1:4) molar ratio as a slurry in methanol. The gold (III) citraconate precipitate is isolated by evaporation of the solvent and washing with methanol. The resulting solid is mixed with a 6:1 ratio of amylamine to form a translucent solution of gold (III) citraconate. This solution is then deposited on a substrate and heated to 100° C. for 5-10 minutes. At this temperature the solution fully decomposes to metallic gold and forms a continuous, highly conductive film (<0.1 ohms per square (OPS)).

The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art.

In some embodiments, the numbers expressing quantities of ingredients, properties such as molecular weight, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the invention (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

In closing, it is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

What is claimed is:

1. An ink composition for making a conductive gold structure, the ink composition comprising:
a gold salt; and
a complexing agent, optionally further comprising a short chain carboxylic acid or salt thereof,
wherein the gold salt is a carboxylate, or the gold salt is capable of forming a carboxylate with the short chain carboxylic acid or with the salt thereof.

2. The ink composition of claim 1, wherein the gold salt is a gold (I) salt, a gold (II) salt, or a gold (III) salt.

3. The ink composition of claim 1, wherein the gold salt is gold(III) formate, gold(III) acetate, gold(III) propionate, gold(III) lactate, gold(III) oxalate, gold(III) carbonate, gold(III) nitrate, gold(III) nitrite, gold(III) phosphate, gold(III) oxide, gold(III) fluoride, gold(III) bromide, gold(I) chloride, gold(III) chloride, gold(III) chloride trihydrate, gold(III) hydroxide, gold(I) iodide, hydrogen tetrabromoaurate(III) hydrate, potassium gold(III) chloride, or gold(III) terephthalate.

4. The ink composition of claim 1, wherein the gold salt is a gold carboxylate.

5. The ink composition of claim 1, wherein the molar ratio of complexing agent to the gold salt is around 6:1.

6. The ink composition of claim 1, wherein the complexing agent is an alkyl amine or ammonia.

7. The ink composition of claim 6, wherein the alkyl amine is a primary amine, a secondary amine, or a polyamine.

8. The ink composition of claim 6, wherein the alkyl amine is selected from the group consisting of methylamine, dimethylamine, ethylamine, diethylamine, propylamine, dipropylamine, butylamine, dibutylamine, amylamine, isoamylamine, dipentylamine, and combinations thereof.

9. The ink composition of claim 1, wherein the short chain carboxylic acid is selected from the group consisting of formic acid, acetic acid, propionic acid, lactic acid, oxalic acid, citric acid, and citraconic acid.

10. The ink composition of claim 1, further comprising methylene diamine or ethylene diamine.

11. The ink composition of claim 1, further comprising a solvent selected from the group consisting of ethanol, butanol, propylene glycol, water, and combinations thereof.

12. The ink composition of claim 1, wherein the gold salt is gold(III) formate, and
wherein the complexing agent is selected from the group consisting of methylamine, dimethylamine, ethylamine, diethylamine, propylamine, dipropylamine, butylamine, dibutylamine, amylamine, dipentylamine, ammonia, and combinations thereof.

13. The ink composition of claim 1, wherein the complexing agent is selected from the group consisting of methylamine, dimethylamine, ethylamine, diethylamine, propylamine, dipropylamine, butylamine, dibutylamine, amylamine, dipentylamine, ammonia, and combinations thereof, and
wherein the short chain carboxylic acid is acetic acid.

14. The ink composition of claim 13, further comprising ethylene diamine.

15. The ink composition of claim 13, further comprising a solvent selected from the group consisting of ethanol, butanol, propylene glycol, water, and combinations thereof.

16. An ink composition for making a conductive structure comprising gold, the ink composition comprising:
a gold salt of an organic acid;
a monomeric building block; and
a solvent having a boiling point of about 160° C. or less;
wherein the conjugate base of the organic acid reacts with the monomeric building block to form a polymer while ionic gold is reduced to elemental gold.

17. The ink composition of claim 16, wherein the polymer is a polyamide, a polyimide, a polyamideimide, or a polyester.

18. The ink composition of claim 16, wherein the organic acid comprises a dicarboxylic acid selected from the group consisting of oxalic acid, malonic acid, succinic acid, glutaric acid, adipic acid, pimelic acid, suberic acid, azelaic acid, sebacic acid, undecanedioic acid, dodecanedioic acid, tridecanedioic acid, hexadecanedioic acid, and terephthalic acid.

19. The ink composition of claim 16, wherein the monomeric building block comprises a diamine, an N-silylated diamine, or a diisocyanate.

20. The ink composition of claim 19, wherein the diamine comprises a linear aliphatic diamine, a branched aliphatic diamine, a cyclic aliphatic diamine, or an aromatic diamine.

21. The ink composition of claim 19, wherein the monomeric building block is selected from the group consisting of ethylenediamine, an N-alkylated diamine, 1,1-dimethylethylenediamine, 1,1-dimethylethylenediamine, tetramethylethylenediamine, ethambutol, TMEDA, 1,3-diaminopropane, putrescine, cadaverine, or hexamethylenediamine, ethylenediamine, 1,2-diaminopropane, diphenylethylenediamine, trans-1,2-diaminocyclohexane, 1,4-Diazacycloheptane, o-xylylenediamine, m-xylylenediamine, p-xylylenediamine, o-phenylenediamine, m-phenylenediamine, p-phenylenediamine, 2,5-diaminotoluene, an N-methylated derivative of a phenylenediamine, imethyl-4-phenylenediamine, N,N′-di-2-butyl-1,4-phenylenediamine, a diamine with two aromatic rings, 4,4′-diaminobiphenyl or 1,8-diaminonaphthalene, toluene diisocyanate, methylene diphenyl diisocyanate, hexamethylene diisocyanate, methyl isocyanate, and isophorone diisocyanate.

22. The ink composition of claim 16, wherein the polymer is a polyimide formed a poly(amic acid) precursor, a polyisoimide precursor, a mixture of a diester-acid and a diamine, a mixture of a tetracarboxylic acid and a diamine, a mixture of a dianhydride and a diisocyanate, a polyetherimide via a nucleophilic aromatic substitution reaction, or a mixture of 4,4′-methylenediphenyldiisocyanate and trimellitic anhydride.

23. The ink composition of claim 17, wherein the polyester is selected from the group consisting of polyethylene adipate, polybutylene succinate, poly(3-hydroxybutyrate-co-3-hydroxyvalerate), polyethylene terephthalate, polybutylene terephthalate, polytrimethylene terephthalate, polyethylene naphthalate, and Vectran.

24. A method of making a conductive structure comprising gold, the method comprising:
providing a metal salt composition comprising a gold salt and a complexing agent;
adding a short chain carboxylic acid or a salt thereof to the combined metal salt composition and complexing agent to form an ink composition;
optionally partially evaporating the complexing agent from the ink composition to form a concentrated formulation; and
reducing the metal salt composition to form a conductive structure comprising gold,
wherein the concentrated formulation and the conductive structure comprising gold are formed at a temperature of about 160° C. or less.

25. The method of claim 24, wherein the temperature is about 140° C. or less.

26. The method of claim 24, wherein the short chain carboxylic acid or the salt of the short chain carboxylic acid is not added until after the gold salt is dissolved in the complexing agent.

27. The method of claim 24, further comprising depositing the ink composition onto a substrate.

28. The method of claim 27, wherein the ink composition is deposited onto the substrate by a method selected from the group consisting of spray processing, dip coating, spin coating, inkjet printing and e-jet printing.

29. The method of claim 24, further comprising depositing the concentrated formulation onto a substrate.

30. The method of claim 29, wherein the concentrated formulation is deposited onto the substrate by a method selected from the group consisting of screen printing, roll-to-roll processing, and direct ink writing.

31. A method of making a conductive structure comprising gold, the method comprising:
providing a gold salt of an organic acid and a monomeric building block; and
causing polymer formation between the conjugate base of the organic acid and the monomeric building block.
